(19) United States
(12) Patent Application Publication
(10) Pub. No.: US 2022/0251291 A1
(43) Pub. Date: Aug. 11, 2022

(54) Polybutylene Terephthalate With Low THF Content

(71) Applicant: LANXESS Deutschland GmbH, Cologne (DE)

(72) Inventors: Matthias Bienmueller, Krefeld (DE); Sebastian Harms, Cologne (DE)

(73) Assignee: LANXESS Deutschland GmbH, Cologne (DE)

(21) Appl. No.: 17/630,545

(22) PCT Filed: Jul. 27, 2020
(86) PCT No.: PCT/EP2020/071156

§ 371 Date: Jan. 27, 2022

(30) Foreign Application Priority Data
Jul. 29, 2019 (EP) 19188765.2

(51) Int. Cl. C08G 63/183; C08L 67/02; C08K 7/14; C08K 9/06; B29C 45/00; B29C 48/00; B29C 48/40

(52) U.S. Cl. CPC C08G 63/183; C08L 67/02; C08K 7/14; C08K 9/06; C08L 2203/30; B29C 48/022; B29C 48/40; C08L 2205/025; B29C 45/0001

(57) ABSTRACT

The invention relates to the use of polyethylene terephthalate for production of polybutylene terephthalate-based automotive interior parts having a low TVOC content and a low tetrahydrofuran content by injection molding, wherein TVOC stands for “Total Volatile Organic Compounds”.

The invention relates to the use of polyethylene terephthalate for production of polybutylene terephthalate-based automotive interior parts having a low TVOC content and a low tetrahydrofuran content by injection molding, wherein TVOC stands for “Total Volatile Organic Compounds”.

Despite a certain complexity the past has seen no lack of attempts to find a means of assessing the multiplicity of volatile organic compounds, VOC for short, encountered in interiors. Use is made for this purpose of a construct in the form of an indicator parameter where as an indicator for the VOC concentration in interiors the sum of the concentrations of the individual compounds is employed and used to determine the TVOC value (total volatile organic compounds); see: B. Seifert, Bundesgesundheitsblatt-Gesundheitsforschung-Gesundheitsschutz, 42, pages 270-278, Springer-Verlag 1999.

Unlike when determining an individual substance in indoor air, where the “measured object” is unambiguously defined, for example the determination of n-decane, toluene or formaldehyde in particular, in the analysis of a VOC mixture it it is necessary to consider which substances are to be described as VOCs. In order to achieve a uniform approach in this regard, a working group of the World Health Organization which dealt with organic substances in indoor air carried out a classification of the organic compounds at an early stage. This WHO classification, which is based on boiling points, is shown in Tab. 1 and it must be noted that under this definition neither formaldehyde nor diethylhexyl phthalate belong to the VOCs.

TABLE 1
Classification of organic compounds in indoor air; according to WHO

| Group name* | Abbreviation | Boiling point range** [° C.] | Sampling technique |
|---|---|---|---|
| Very volatile organic | VVOC | <0 to 50-100 | Gas collecting tube or |
| compounds | | | canister; adsorption on |
| | | | activated carbon |
| Volatile organic | VOC | 50-100 to 250-260 | Adsorption on Tenax, |
| compounds | | | graphitized carbon or |
| | | | activated carbon |
| Semivolatile organic | SVOC | 250-260 to 380-500 | Adsorption on |
| compounds | | | polyurethane foam or XAD- |
| | | | 2 |
| Organic compounds | POM | >380 | Sampling with filters |
| associated with particulate | | | |
| matter or particulate | | | |
| organic matter | | | |

*In order to better document the origin of the abbreviations also used in German texts this column of Tab. 1 uses the English descriptions. The corresponding German terms are as follows: VVOC = Sehr/leicht flüchtige organische Verbindungen [very volatile organic compounds], VOC = Flüchtige organische Verbindungen (häufig als FOV abgekürzt) [volatile organic compounds (often abbreviated to FOV)], SVOC = Schwerflüchtige organische Verbindungen [semivolatile organic compounds], POM = Partikelgebundene organische Verbindungen [particulate organic matter];
**Polar compounds are at the upper end of the range

According to G. Blinne, Kunststoffe October 1999 polybutylene terephthalate (PBT) in the form of compounds, preferably reinforced with glass fibers, is an essential plastic in the electrical engineering/electronics sectors and the vehicle industry, especially the automotive industry. Thus AutomobilKONSTRUKTION February 2011, pages 18-19 describes the use of PBT blends for delicate loudspeaker grills and ventilation grills in automotive interior parts. WO 2013/020627 A1 describes functionalized interior trim components for a motor vehicle, the production of which may inter alia employ PBT as a matrix plastic.

As a semicrystalline plastic, PBT has a narrow melting range in the range from 220° C. to 225° C. The high crystalline proportion makes it possible for stress-free molded parts made of PBT to be subjected to short-term heating to below the melting temperature without deformation and damage. Pure PBT melts exhibit short-term thermal stability up to 280° C. and do not undergo substantial molecular degradation nor exhibit substantial evolution of gases and vapors. However, like all thermoplastic polymers PBT does decompose under excessive thermal stress, in particular upon superheating or during cleaning by burn-off methods. This forms gaseous decomposition products. Decomposition accelerates above about 300° C. and initially mainly tetrahydrofuran (THF) and water are formed.

According to EP 2 029 271 A1 THF is already formed during production of PBT through intramolecular condensation from the monomer 1,4-butanediol (BDO). The reaction can be catalyzed both by the employed terephthalic acid (PTA) and by the titanium-based catalyst usually used to produce the PBT. It is alternatively possible to use dimethyl terephthalate (DMT) instead of PTA.

However, THF is also continuously regenerated in the PBT melt at high temperatures. This process, also referred to as “back-biting”, takes place at the BDO end groups. Similarly to THF formation from BDO monomer, this reaction is an intramolecular condensation which affords the undesired byproduct tetrahydrofuran. The THF regeneration from the polymer in the melt is also catalyzed both by acid end groups (PTA) and by any (titanium-based) catalyst present.

The effects of tetrahydrofuran on human health and the environment have been tested by Germany in 2013 as part of a substance assessment under REACH. The IARC (International Agency for Research on Cancer) classified tetrahydrofuran as a possible carcinogen in 2017.

Apart from technical measures to avoid THF during the production of PBT, increasing health awareness and increasing consumer demands on the olfactory quality of motor vehicles mean that efforts are being made to reduce or even completely avoid any outgassing from materials used in the automotive interior, in particular under the influence of elevated temperatures as a result of solar radiation. To this end the Verband der Automobilhersteller (VDA) has issued two test specifications based on different gas chromatographic methods, VDA 277 and VDA 278, to quantify the outgassing from components used in vehicle interiors.

VDA 277, which is based on a static headspace method and flame ionization detection (FID) and indicates the total TVOC content of volatile carbon compounds (TVOC=Total Volatile Organic Compounds), was published in 1995. This was followed in 2002 by VDA 278, which is based on a dynamic headspace method, so-called thermal desorption, and indicates both the volatile organic compounds (VOC) and the condensable components (fog value). The corresponding threshold values, which always apply to components after injection molding, are set by the automakers (OEMs) but are usually based on the suggestions of the VDA.

In view of the requirements of VDA 277, therefore, numerous attempts to reduce the THF emissions of PBT have hitherto been made:

EP 0 683 201 A1 Addition of a sulfonic acid component during the polymerization, though the sulfonic acid components themselves have now been classified as health-hazardous to carcinogenic;

EP 1 070 097 A1 (WO99/50345 A1) Addition of polyacrylic acid to polyesters based on lactic acid during polymerization to deactivate Sn or Sb catalysts used in PBT production;

EP 1 999 181 A2 (WO2007/111890A2) Addition of a phosphorus-containing component to deactivate the titanium catalyst used in PBT production. The values of the emissions specified in EP 1 999 181 A2 are percentages, i.e. they are not absolute values and are in any case in need of improvement;

EP 2 427 511 B1 Addition of a styrene-acrylic polymer (for example Joncryl®ADR-4368) in a concentration of 0.01% to 2%, but this resulted in chain extension and an increase in the molecular weight of the PBT;

EP 2 816 081 A1 Addition of a chelating agent from the group of sodium hypophosphite, nitrilotriacetic acid, disodium salt of EDTA, diammonium salt of EDTA, EDTA, diethylenetriaminepentaacetic acid, hydroxyethylenediaminetriacetic acid, ethylenediaminedisuccinic acid and, in particular, 1,3-propylenediaminetetraacetic acid;

EP 3 287 493 A1 discloses in its examples injection molding compositions comprising 100 parts by weight of polybutylene terephthalate, 8.4 or 8.7 parts by weight of polyethylene terephthalate and 50 or 52 parts by weight of silane-coated glass fibers;

JP 2016 145333 A teaches in example 1 an injection molding composition comprising 100 parts by weight of polybutylene terephthalate, about 13 parts by weight of polyethylene terephthalate and glass fibers;

EP 3 004 242 A1 (WO2014/195176 A1) Addition of sodium hypophosphite or epoxy-functionalized styrene-acrylic acid polymer for production of PBT molded parts comprising not more than 100 μgC/g of TVOC according to VDA277.

Proceeding from this prior art it is an object of the present invention to provide PBT-based compounds for injection molding for automotive interior parts having an optimized TVOC value and THF outgassing behavior, wherein the outgassing behavior measured for the injection molded part is to be understood as meaning a TVOC of <50 μgC/g according to VDA 277 and a VOC_{THF} of <5 μg/g according to VDA 278 as per the Verband der Automobilindustrie (VDA). This object shall preferably be achieved without the use of the additives recited in the above prior art.

It has now been found that, surprisingly, polyethylene terephthalate (PET) alone leads to a reduction in the outgassing of THF from PBT and thus makes it possible to achieve compliance not only with the requirements of VDA 277 but also in addition with the requirements of VDA 278 for PBT-based components in automotive interiors.

Experiments in the context of the present invention have surprisingly shown that the addition of the PET to be employed according to the invention results in a significant reduction in the total emission TVOC and the THF emission TVOC_{THF} or VOC_{THF} which goes beyond the diluting effect of the PET. Solely through the use of PET according to the invention the measurable TVOC value for the component manufactured by injection molding according to VDA 277 fell from on average 90 to 100 μgC/g to below 45 μgC/g. The THF content fell from on average 80-85 μgC/g to below 30 μgC/g. The presence of PET reduced the VOC_{THF} according to VDA 278 by on average 6 to 7 μg/g to below 2 μg/g. All information relates to the condition defined in the corresponding test specification as described hereinbelow.

The invention relates to automotive interior parts containing compounds based on PBT and PET, wherein per 100 parts by mass of PBT the compounds employ 5 to 30 parts by mass of PET, preferably having a TVOC to be determined according to VDA 277 of <50 μgC/g and a VOC_{THF} to be determined according to VDA 278 of <5 μg/g and with the proviso that PET and PBT are present not as a copolymer but rather as a mixture.

The invention also relates to the use of PET for production of PBT-based compounds for processing by injection molding into components in automotive interiors having a TVOC to be determined according to VDA 277 of <50 μgC/g and a VOC_{THF} to be determined according to VDA 278 of <5 μg/g, wherein per 100 parts by mass of PBT 5 to 30 parts by mass of PET are employed, with the proviso that PET and PBT are present not as a copolymer but rather as a mixture.

The invention finally relates to a method for reducing the THF content in PBT-based automotive interior parts, characterized in that their production by injection molding employs polybutylene terephthalate-based compounds comprising at least polyethylene terephthalate, wherein per 100 parts by mass of polybutylene terephthalate 5 to 30 parts by mass of polyethylene terephthalate are present, with the proviso that polybutylene terephthalate and polyethylene terephthalate are present not as a copolymer but rather as a mixture.

For the sake of clarity it is noted that the scope of the present invention comprises all of the definitions and parameters recited below in general or in preferred ranges in any desired combinations. Unless otherwise stated the standards recited in the context of this application relate to the edition current on the application date of the present invention. The melt index, MFR=Melt mass-Flow Rate or MFI=Melt Flow Index, is used to characterize the flow behavior of a thermoplastic material. Measurement of the melt index is effected using melt index measuring instruments which represent a special embodiment of a capillary rheometer. Melt index determination is standardized in DIN EN ISO 1133 [2]. This defines as the melt index the MFR value which specifies the amount of material in grams flowing through a capillary having defined dimensions in ten minutes at a particular pressure and a particular temperature. The melt index is reported in units of g·(10 min)⁻¹; see: Schmelze-Massefließrate (wiki.polymerservice-merseburg.de/index.php?title=Schmelze-Masseflie%C3%/9Frate&printable=yes).

In terms of VDA 277 the present invention refers to the 1995 version while in terms of VDA 278 the present invention refers to the October 2011 version.

The testing of TVOC, TVOC_{THF} and of VOC_{THF} in the context of the present invention was carried out according to the specifications of the respective standard:

VDA 277 specifies that sampling must be carried out immediately after receipt of goods or in a condition corresponding thereto. Transport and storage of the freshly injection molded parts is to be carried out airtightly in aluminum-coated PE (polyethylene) bags, generally without conditioning.

VDA 278 specifies that that the material to be examined should normally be airtightly packaged in aluminum-coated PE bags within 8 hours of manufacture and that the sample should be sent to the laboratory immediately. Prior to measurement the samples are to be conditioned for 7 days under standard climatic conditions (23° C., 50% relative humidity).

The TVOC_{THF} determined in the context of the present invention was determined by the same method as TVOC according to VDA277, wherein evaluation was based on the individual substance THF. In the context of the present invention TVOC_{THF} is therefore indicative of the THF emissions behavior of a sample.

In the context of the present invention VOC_{THF} is determined by the same method as VOC according to VDA278, wherein evaluation is based on the individual substance THF. VOC_{THF} is therefore indicative of the THF emission behavior of a sample.

Compounding (to compound=“to put together”) is a term from the plastics industry which describes the processing of plastics by admixing of adjuvants, preferably of fillers, additives etc. to achieve desired profiles of properties. In the context of the present invention compounding is carried out in a twin-screw extruder having a vacuum degassing zone, preferably a co-rotating twin-screw extruder having a vacuum degassing zone. Compounding comprises the process operations of conveying, melting, dispersing, mixing, degassing and pressurization. The product of a compounding is a compound.

The purpose of compounding is to convert the plastic raw material, in the case of the present invention the PBT resulting from the reaction of butanediol with PTA or DMT, into a plastic molding compound having the best possible properties for processing and later use, here in the form of an automotive interior part according to VDA 277 and VDA 278. The objectives of compounding include changing the particle size, incorporating additives and removing constituents. Since many plastics are generated as powders or large particle size resins and are therefore unsuitable for processing machines, especially injection molding machines, the further processing of these raw materials is particularly important. The finished mixture of polymer, here PBT, and additives is called molding compound. Prior to processing, the individual components of the molding compounds may be in various states of matter such as pulverulent, granular or liquid/flowable. The objective of using a compounder is to mix the components as homogeneously as possible to afford the molding compound. Compounding preferably employs the following additives: antioxidants, lubricants, impact modifiers, antistats, fibers, talc, barium sulfate, chalk, heat stabilizers, iron powder, light stabilizers, release agents, demolding agents, nucleating agents, UV absorbers, flame retardants, PTFE, glass fibers, carbon black, glass spheres, silicone.

Compounding may also be used to remove constituents. It is preferable to remove two constituents, namely moisture fractions (dehumidification) or low-molecular weight components (degassing). In the context of the present invention the THF obtained as a byproduct in the synthesis of the PBT is removed from the molding compound by applying a vacuum.

Two essential steps in compounding are mixing and pelletizing. In the context of mixing a distinction is made between distributive mixing, i.e. uniform distribution of all particles in the molding compound, and dispersive mixing, i.e. distribution and comminution of the components to be incorporated. The mixing process itself may be performed either in the viscous phase or in the solid phase. When mixing in the solid phase the distributive effect is preferred since the additives are already in comminuted form. Since mixing in the solid phase is rarely sufficient to achieve a good mixing quality it is often referred to as premixing. The premix is then mixed in the molten state. Viscous mixing generally comprises five operations: melting the polymer and the added substances (as far as possible in the latter case), comminuting the solid agglomerates (agglomerates are conglomerations), wetting the additives with polymer melt, uniformly distributing the components and separating off undesired constituents, preferably air, moisture, solvent and, in the case of the PBT to be considered according to the invention, THF.

The heat required for viscous mixing is substantially caused by the shearing and friction of the components. In the case of the PBT to be considered according to the invention it is preferable to employ viscous mixing.

In order to improve absorption and diffusion of the added substance to the pellets it may be necessary to effect mixing at a relatively high temperature. A heating/cooling mixer system is used here. The material to be mixed is mixed in the heating mixer and then flows into a cooling mixer where it is temporarily stored. This is how dry blends are produced.

It it is preferable to use co-rotating twin-screw extruders/compounding extruders for compounding PBT. The objectives of a compounder/extruder include intake of the plastic composition supplied thereto, compression thereof, simultaneous plasticization and homogenization by supplying energy, and supply to a profiling mold under pressure. Twin-screw extruders having a co-rotating screw pair are suitable for the processing (compounding) of plastics, especially of PBT, on account of their good mixing. A co-rotating twin screw extruder is divided into several processing zones. These zones are interlinked and cannot be considered independently of one another. Thus for example the incorporation of fibers into the melt is carried out not only in the predetermined dispersing zone but also in the discharging zone and in other screw channels.

Since most processors require the plastic, in the present case the PBT, to be in the form of pellets, pelletization plays an ever more important role. A basic distinction is made between hot cutting and cold cutting. This results in different particle forms according to the processing. In the case of hot cutting the plastic is preferably obtained in the form of pearls or lenticular pellets. In the case of cold cutting the plastic is preferably obtained in cylindrical or cubic form.

In the case of hot cutting the extruded strand is chopped immediately downstream of a die by a rotating knife having water flowing over it. The water prevents the individual pellets from sticking together and cools the material. Cooling is preferably effected using water but it is also possible to use air. Selection of the right coolant is therefore material dependent. The disadvantage of water cooling is that the pellets require subsequent drying. In the case of cold cutting the strands are first drawn through a water bath and then cut to the desired length in the solid state by a rotating knife roller (granulator). In the case of the PBT to be employed according to the invention cold cutting is employed.

### PREFERRED EMBODIMENTS OF THE INVENTION

The present invention preferably relates to vehicle interior parts obtainable by injection molding containing compounds based on PBT and at least PET, wherein per 100 parts by mass of PBT 5 to 30 parts by mass of PET are employed, having a TVOC to be determined according to VDA 277 of <50 μgC/g and a VOC_{THF} to be determined according to VDA 278 of <5 μg/g.

Compounder

It is preferable according to the invention to perform the compounding of the PBT for automotive interior parts using a twin-screw extruder, particularly preferably having a co-rotating screw pair. The objectives of a compounder, in particular in the form of a twin-screw extruder, include intake of the plastic composition supplied thereto, compression thereof, simultaneous plasticization and homogenization by supplying energy, and supply to a profiling mold under pressure. Twin-screw extruders preferably employable according to the invention are suitable for compounding PBT, preferably for incorporating at least one filler into the PBT.

Twin-screw extruders to be employed according to the invention are known to those skilled in the art for example from DE 203 20 505 U1 and are preferably marketed by Coperion Werner & Pfleiderer GmbH & Co. KG, Stuttgart. A twin-screw extruder to be employed according to the invention is divided into a plurality of processing zones. These zones are interlinked and cannot be considered independently of one another. DE 203 20 505 U1, the content of which is hereby fully incorporated into the present invention by reference, divides the processing zones, also referred to as the compounding section in the context of the present invention, of a twin-screw extruder preferably employable according to the invention into the feeding means (14), intake zone (15), melting zone (16), atmospheric degassing zone (17), at least one filler feeding zone (18), filler incorporation zone (19), backup zone (20), vacuum degassing zone (21), pressurizing zone (22) and discharging zone (23).

According to the invention the twin-screw extruder is preferably operated at a throughput in the range from 3 to 10 t/h (metric tons per hour).

It is preferable according to the invention to employ a twin-screw extruder having a screw diameter in the range from 60 mm to 100 mm.

It is preferable according to the invention to employ a pressure in the range from 300+/−50 mbar at the vacuum degassing zone of the twin-screw extruder. In the context of the present invention reported pressures are subatmospheric pressures/vacuums and are based on the respective prevailing atmospheric pressure (relative pressure). According to DIN 28400-1 a vacuum is defined as “the state of a gas when the pressure of the gas and thus the particle number density is lower in a container than outside, or when the pressure of the gas is lower than 300 mbar, i.e. less than the lowest atmospheric pressure on the earth's surface”.

The pressure of 300+/−50 mbar at the vacuum degassing zone of the twin-screw extruder as sought in accordance with the invention is achieved using vacuum pumps from the range of rotary vane pumps, liquid ring pumps, scroll pumps, Roots pumps and screw pumps. See: 1.1.1 Vakuum-Definition (pfeiffer-vacuum.com/de/know-how/einfuehrung-in-die-vakuumtechnik/allgemeines/vakuum-definition/).

The compounding section of a twin-screw extruder to be employed according to the invention comprises a feeding means, intake zone, melting zone, atmospheric degassing zone, at least one filler feeding zone, filler incorporation zone, backup zone, vacuum degassing zone, pressurization zone and discharging zone. According to the invention the vacuum degassing zone is located in the last third of the compounding section, wherein the last third is based on the total length of the twin-screw extruder. The total length of the twin-screw extruder is defined as the distance between the start of the intake zone and the end of the discharging zone. The last third expressly includes the discharging zone.

The result of the compounding of PBT with PET, preferably in a twin-screw extruder, is a low-THF PBT compound in pellet form with a very low THF content. This THF content is so low that even after processing of the pellets in injection molding, wherein decomposition processes result in THF regeneration, it is still possible to mold products, especially automotive interior parts, having a TVOC to be determined according to VDA 277 of <50 μgC/g and a VOC_{THF} to be determined according to VDA 278 of <5 μg/g.

Polybutylene Terephthalate

PBT employable according to the invention [CAS No. 24968-12-5] is available for example from Lanxess Deutschland GmbH, Cologne under the trade name Pocan®.

The viscosity number of the PBT to be employed according to the invention to be determined in a 0.5% by weight solution in a phenol/o-dichlorobenzene mixture (weight ratio 1:1 at 25° C.) according to DIN EN ISO 1628-5 is preferably in a range from from 50 to 220 cm³/g, particularly preferably in the range from 80 to 160 cm³/g; see: Schott Instruments GmbH brochure, O. Hofbeck, 2007-07.

Especial preference is given to PBT whose carboxyl end group content to be determined by titration methods, in particular potentiometry, is up to 100 meq/kg, preferably up to 50 meq/kg and in particular up to 40 meq/kg polyester. Such polyesters are producible for example by the method of DE-A 44 01 055. The content of carboxyl end groups (CEG) in the PBT to be employed according to the invention was in the context of the present invention determined by potentiometric titration of the acetic acid liberated when a sample of the PBT dissolved in nitrobenzene was reacted with a defined excess of potassium acetate.

Polyalkylene terephthalates are preferably produced with Ti catalysts. After polymerization a PBT to be employed according to the invention preferably has a Ti content to be determined by X-ray fluorescence analysis (XRF) according to DIN 51418 of 250 ppm, particularly preferably <200 ppm, especially preferably <150 ppm. Such polyesters are preferably produced according to the method in DE 101 55 419 B4, the content of which is hereby fully incorporated by reference.

Polyethylene Terephthalate (PET)

The PET (CAS No. 25038-59-9) to be employed as a mixing partner for reducing the THF content in PBT is a reaction product of an aromatic dicarboxylic acid or reactive derivatives thereof, preferably dimethyl esters or anhydrides, and an aliphatic, cycloaliphatic or araliphatic diol and mixtures of these reactants. PET preferably employable according to the invention is produced by known methods from terephthalic acid (or its reactive derivatives) and the aliphatic diol having 2 carbon atoms (Kunststoff-Handbuch, Vol. VIII, pp. 695-703, Karl-Hanser-Verlag, Munich 1973). The PET is preferably incorporated via at least one filler feeding zone in the compounding section of the twin-screw extruder.

Preferably employable PET contains at least 80 mol %, particularly preferably at least 90 mol %, based on the dicarboxylic acid, of terephthalic acid radicals and at least 80 mol %, preferably at least 90 mol %, based on the diol component, of ethylene glycol radicals.

Preferably employable PET may contain not only terephthalic acid radicals but also up to 20 mol % of radicals of other aromatic dicarboxylic acids having 8 to 14 carbon atoms or radicals of aliphatic dicarboxylic acids having 4 to 12 carbon atoms, particularly preferably radicals of phthalic acid, isophthalic acid, naphthalene-2,6-dicarboxylic acid, 4,4′-biphenyldicarboxylic acid, succinic acid, adipic acid, sebacic acid, azelaic acid, cyclohexanediacetic acid or cyclohexanedicarboxylic acid.

Preferably employable PET may contain not only ethylene glycol radicals but also up to 20 mol % of other aliphatic diols having 3 to 12 carbon atoms or cycloaliphatic diols having 6 to 21 carbon atoms. Particular preference is given to radicals of propane-1,3-diol, 2-ethylpropane-1,3-diol, neopentyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,6-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane or 2,2-bis(4-hydroxypropoxyphenyl)propane (DE-A 24 07 674 DE-A 24 07 776, DE-A 27 15 932).

In one embodiment the PET to be employed as a mixing partner according to the invention may be branched through incorporation of relatively small amounts of tri- or tetrahydric alcohols or tri- or tetrabasic carboxylic acids, such as are described for example in DE-A 19 00 270. Preferred branching agents are trimesic acid, trimellitic acid, trimethylolethane and trimethylolpropane, and pentaerythritol.

PET to be employed as a mixing partner of the PBT according to the invention preferably has an intrinsic viscosity in the range from about 30 cm³/g to 150 cm³/g, particularly preferably in the range from 40 cm³/g to 130 cm³/g, especially preferably in the range from 50 cm³/g to 100 cm³/g, in each case measured analogously to ISO 1628-1 in phenol/o-dichlorobenzene—1:1 parts by weight—at 25° C. using an Ubbelohde viscometer. The viscosity is measured by drying the material to a moisture content of not more than 0.02%, determined by means of the Karl Fischer method known to those skilled in the art, in a commercial air circulation dryer at 120° C.

Fillers

In a preferred embodiment in addition to the polybutylene terephthalate and the polyethylene terephthalate at least one filler is incorporated via at least one filler feeding zone in the compounding sector of the twin-screw extruder. In this case compounds according to the invention preferably contain 0.001 to 70 parts by mass, particularly preferably 5 to 50 parts by mass, very particularly preferably 9 to 48 parts by mass, of at least one filler, in each case based on 100 parts by mass of polybutylene terephthalate.

Fillers to be employed according to the invention are preferably selected from the group consisting of talc, mica, silicate, quartz, titanium dioxide, wollastonite, kaolin, kyanite, amorphous silicas, magnesium carbonate, chalk, feldspar, barium sulfate, glass spheres and fibrous fillers, in particular glass fibers or carbon fibers. It is especially preferable to employ glass fibers.

According to Faser-Kunststoff-Verbund (de.wikipedia.org/wiki/), a distinction is made between chopped fibers, also known as short fibers, having a length in the range from 0.1 to 1 mm, long fibers having a length in the range from 1 to 50 mm and continuous fibers having a length L>50 mm. Short fibres are used in injection moulding and are directly processable with an extruder. Long fibres can likewise still be processed in extruders. Said fibres are widely used in fibre spraying. Long fibres are frequently added to thermosets as a filler. Continuous fibres are used in the form of rovings or fabric in fibre-reinforced plastics. Products comprising continuous fibres achieve the highest stiffness and strength values. Also available are ground glass fibers, the length of these after grinding typically being in the range from 70 to 200 μm.

It is preferable according to the invention to employ as filler chopped long glass fibers having a starting length in the range from 1 to 50 mm, particularly preferably in the range from 1 to 10 mm, very particularly preferably in the range from 2 to 7 mm. Initial length refers to the average length of the glass fibres as present prior to compounding of the compounds according to the invention to afford a moulding compound according to the invention. The fibers, preferably glass fibers, employable as filler may as a consequence of compounding in the product have a d90 and/or d50 value smaller than the originally employed fibers or glass fibers. Thus, the arithmetic average of the fiber length/glass fiber length after processing is frequently only in the range from 150 μm to 300 μm as determinable by laser diffractometry according to ISO 13320.

In the context of the present invention the fiber length and fiber length distribution/glass fiber length and glass fiber length distribution are in the case of processed fibers/glass fibers determined according to ISO 22314 which initially provides for ashing the samples at 625° C. Subsequently, the ash is placed onto a microscope slide covered with demineralized water in a suitable crystallizing dish and the ash is distributed in an ultrasound bath without action of mechanical forces. The next step comprises drying in an oven at 130° C., which is followed by determination of glass fiber length with the aid of optical microscopy images. For this purpose, at least 100 glass fibres are measured from three images, and so a total of 300 glass fibres are used to ascertain the length. The glass fiber length can be calculated here either as the arithmetic average lₙ according to the equation

$${I}_{n} = \frac{1}{n} \cdot {\sum }_{i}^{n} {I}_{i}$$

where lᵢ=length of the ith fiber and n=number of measured fibers and suitably shown as a histogram or for an assumed normal distribution of the measured glass fiber lengths l may be determined using the Gaussian function according to the equation

$$f ( l ) = \frac{1}{\sqrt{2 π} \cdot σ} \cdot {e}^{- \frac{1}{2} {( \frac{I - {I}_{c}}{σ} )}^{2}}$$

In this equation, l_{c} and σ are specific parameters of the normal distribution: l_{c} is the mean and σ is the standard deviation (see: M. Schoßig, Schädigungsmechanismen in faserverstärkten Kunststoffen, 1, 2011, Vieweg and Teubner Verlag, page 35, ISBN 978-3-8348-1483-8). Glass fibers not incorporated into a polymer matrix are analysed with respect to their lengths by the above methods, but without processing by ashing and separation from the ash.

The glass fibres [CAS No. 65997-17-3] preferably employable as filler according to the invention preferably have a fiber diameter in the range from 7 to 18 μm, particularly preferably in the range from 9 to 15 μm, determinable by at least one means available to the skilled person, in particular determinable by X-ray computed tomography analogously to “Quantitative Messung von Faserlängen und-verteilung in faserverstärkten Kunststoffteilen mittels μ-Röntgen-Computertomographie”, J. KASTNER, et al. DGZfP-Jahrestagung 2007—Vortrag 47. The glass fibers preferably employable as filler are preferably added in the form of chopped or ground glass fibers.

In a preferred embodiment the fillers, preferably glass fibers, are treated with a suitable size system or an adhesion promoter/adhesion promoter system. Preference is given to using a silane-based size system or adhesion promoter. Particularly preferred silane-based adhesion promoters for the treatment of the glass fibres preferably employable as filler are silane compounds of general formula (I)

(X—(CH₂)_{q})ₖ—Si—(O—CrH₂ᵣ₊₁)₄₋ₖ (I)

wherein

X is NH₂—, carboxyl-, HO— or

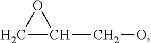

q is an integer from 2 to 10, preferably 3 to 4,

r is an integer from 1 to 5, preferably 1 to 2, and

k is an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane and the corresponding silanes comprising as the substituent X a glycidyl group or a carboxyl group, wherein carboxyl groups are especially particularly preferred.

For the treatment of the glass fibres preferably employable as filler the adhesion promoter, preferably the silane compounds of formula (I), is employed preferably in amounts of 0.05% to 2% by weight, particularly preferably in amounts of 0.25% to 1.5% by weight and very particularly preferably in amounts of 0.5% to 1% by weight, in each case based on 100% by weight of the filler.

As a consequence of the processing to afford the compound/to afford the product the glass fibres preferably employable as filler may be shorter in the compound/in the product than the originally employed glass fibers. Thus, the arithmetic average of the glass fibre length after processing, to be determined by high-resolution x-ray computed tomography, is frequently only in the range from 150 μm to 300 μm.

According to Glasfasern (r-g.de/wiki/), glass fibres are produced in the melt spinning process (die drawing, rod drawing and die blowing processes). In the die drawing process, the hot mass of glass flows under gravity through hundreds of die bores of a platinum spinneret plate. The filaments can be drawn at a speed of 3-4 km/minute with unlimited length.

Those skilled in the art distinguish between different types of glass fibres, some of which are listed here by way of example:
E glass, the most commonly used material having an optimal cost-benefit ratio (E glass from R&G)
H glass, hollow glass fibres for reduced weight (R&G hollow glass fibre fabric 160 g/m² and 216 g/m²)
R, S glass, for elevated mechanical requirements (S2 glass from R&G)
D glass, borosilicate glass for elevated electrical requirements
C glass, having increased chemical resistance
Quartz glass, having high thermal stability

Further examples can be found at Glasfaser (de.wikipedia.org/wiki/). E glass fibres have gained the greatest importance for plastics reinforcing. E stands for electrical glass, since it was originally used in the electrical industry in particular.

For the production of E glass, glass melts are produced from pure quartz with additions of limestone, kaolin and boric acid. As well as silicon dioxide, they contain different amounts of various metal oxides. The composition determines the properties of the products. Preference is given in accordance with the invention to using at least one type of glass fibres from the group of E glass, H glass, R, S glass, D glass, C glass and quartz glass, particular preference being given to using glass fibres made of E glass.

Glass fibres made of E glass are the most commonly used reinforcing material. The strength properties correspond to those of metals (for example aluminium alloys), the specific weight of laminates containing E glass fibres being lower than that of the metals. E glass fibres are nonflammable, heat resistant up to about 400° C. and stable to most chemicals and weathering effects.

Also particularly preferably employed as filler are platelet-shaped mineral fillers. A platelet-shaped mineral filler is according to the invention to be understood as meaning at least a mineral filler having a strongly pronounced platelet-shaped character from the group of kaolin, mica, talc, chlorite and intergrowths such as chlorite talc and plastorite (mica/chlorite/quartz). Talc is particularly preferred.

The platelet-shaped mineral filler preferably has a length:diameter ratio for determination by high-resolution x-ray computed tomography in the range from 2:1 to 35:1, more preferably in the range from 3:1 to 19:1, especially preferably in the range from 4:1 to 12:1. The average particle size of the platelet-shaped mineral fillers for determination by high-resolution x-ray computed tomography is preferably less than 20 μm, particularly preferably less than 15 μm, especially preferably less than 10 μm.

Also preferably employed as filler however is non-fibrous and non-foamed milled glass having a particle size distribution to be determined by laser diffractometry according to ISO 13320 having a d90 value in the range from 5 to 250 μm, preferably in the range from 10 to 150 μm, particularly preferably in the range from 15 to 80 μm, very particularly preferably in the range from 16 to 25 μm. In connection with the d90 values, their determination and their significance, reference is made to Chemie Ingenieur Technik (72) S. 273-276, 3/2000, Wiley-VCH Verlags GmbH, Weinheim, 2000, according to which the d90 value is that particle size below which 90% of the amount of particles lie (median value).

It is preferable according to the invention when the non-fibrous and non-foamed milled glass has a particulate, non-cylindrical shape and has a length to thickness ratio to be determined by laser diffractometry according to ISO 13320 of less than 5, preferably less than 3, particularly preferably less than 2. It will be appreciated that the value of zero is impossible.

The non-foamed and non-fibrous milled glass particularly preferably employable as filler is additionally characterized in that it does not have the glass geometry typical of fibrous glass with a cylindrical or oval cross section having a length to diameter ratio (L/D ratio) to be determined by laser diffractometry according to ISO 13320 greater than 5.

The non-foamed and non-fibrous milled glass particularly preferably employable as filler according to the invention is preferably obtained by milling glass with a mill, preferably a ball mill and particularly preferably with subsequent sifting or sieving. Preferred starting materials for the milling of the non-fibrous and non-foamed milled glass for use as filler in one embodiment also include glass wastes such as are generated as unwanted byproduct and/or as off-spec primary product (so-called offspec goods) in particular in the production of glass articles of manufacture. This includes in particular waste glass, recycled glass and broken glass such as may be generated in particular in the production of window or bottle glass and in the production of glass-containing fillers, in particular in the form of so-called melt cakes. The glass may be coloured, but preference is given to non-coloured glass as the starting material for use as filler.

Particularly preferred according to the invention are long glass fibers based on E glass (DIN 1259), preferably having an average length d50 of 4.5 mm, such as are obtainable for example from LANXESS Deutschland GmbH, Cologne, as CS 7967.

Other Additives

In a preferred embodiment the PBT may according to the invention have further additives added to it in addition to the PET and optionally the filler. Additives preferably employable according to the invention are stabilizers, in particular UV stabilizers, heat stabilizers, gamma ray stabilizers, also antistats, elastomer modifiers, flow promoters, demolding agents, flame retardants, emulsifiers, nucleating agents, plasticizers, lubricants, dyes, pigments and additives for increasing electrical conductivity. These and further suitable additives are described, for example, in Gächter, Müller, Kunststoff-Additive, 3rd Edition, Hanser-Verlag, Munich, Vienna, 1989 and in Plastics Additives Handbook, 5th Edition, Hanser-Verlag, Munich, 2001. The additives may be employed alone or in admixture/in the form of masterbatches.

Automotive interior parts In the context of the present invention the term automotive interior part relates to all injection molded parts that are not constituents of the outer surface of a motor vehicle or that do not have any proportion of their area on the outer surface of a motor vehicle.

Injection molded parts for an automotive interior part to be produced according to the invention include not only the components described in the prior art above but also preferably trim pieces, plugs, electrical components or electronic components. These are installed in increasing numbers in the interior of modern automobiles to enable the increasing electrification of many components, in particular vehicle seats or infotainment modules. PBT-based components are also often used in automobiles for functional parts that are subject to mechanical stress.

The present invention preferably relates to automotive interior parts containing compounds based on PBT in admixture with PET and at least one filler, preferably glass fibers, wherein per 100 parts by mass of PBT the compounds employ 5 to 30 parts by mass of PET, preferably 10 to 25 parts by mass of PET, particularly preferably 12 to 17 parts by mass of PET, and 0.001 to 70 parts by mass, particularly preferably 5 to 50 parts by mass, very particularly preferably 9 to 48 parts by mass, of filler, preferably having a TVOC to be determined according to VDA 277 of <50 μgC/g and a VOC_{THF} to be determined according to VDA 278 of <5 μg/g.

Production Process for Components of the Automotive Interior Part

The processing of PBT-based compounds to be employed according to the invention is carried out in four steps:
1) polymerization of the PBT from BDO and PTA or BDO and DMT;
2) compounding by addition of PET and optionally at least one filler, in particular talc or glass fibers, and optionally at least one further additive, in particular heat stabilizer, demolding agent or pigment, to the PBT melt, incorporation and mixing;
3) discharging and solidifying of the melt and pelletization and drying of the pellets with warm air at elevated temperature;
4) production of an automotive interior part from the dried pellets by injection molding.

Injection Molding

Processes according to the invention for producing automotive interior parts by injection molding are performed at melt temperatures in the range from 160° C. to 330° C., preferably in the range from 190° C. to 300° C., and optionally also at pressures of not more than 2500 bar, preferably at pressures of not more than 2000 bar, particularly preferably at pressures of not more than 1500 bar and very particularly preferably at pressures of not more than 750 bar. The PBT-based compounds or compounds according to the invention feature exceptional melt stability, wherein in the context of the present invention melt stability will be understood by those skilled in the art to mean that even after residence times >5 min at markedly above the melting point of the molding compound of >260° C. no increase in the melt viscosity determinable according to ISO 1133 (1997) is observed.

The process of injection molding features melting (plasticizing) the raw material in the form of the compound to be employed according to the invention, preferably in pellet form, in a heated cylindrical cavity, and supply thereof as an injection molding compound under pressure into a temperature-controlled cavity of a profiling mold. Employed as raw material are compounds according to the invention which have preferably already been processed into a molding compound by compounding in a compounder, preferably under vacuum at a pressure of 300+/−50 mbar, where said molding compound has in turn preferably been processed into pellets. However, in one embodiment pelletizing may be eschewed and the molding compound directly supplied under pressure to a profiling mold. After cooling (solidification) of the molding compound injected into the temperature-controlled cavity the injection-molded part is demolded.

The method according to the invention preferably affords automotive interior parts having a TVOC to be determined according to VDA 277 of <50 μgC/g and a VOC_{THF} to be determined according to VDA 278 of <8 μg/g.

The method according to the invention preferably employs polybutylene terephthalate having a viscosity number to be determined in a 0.5% by weight solution at 25° C. in a phenol/o-dichlorobenzene mixture in a weight ratio of 1:1 according to DIN EN ISO 1628-5 in a range from from 50 to 220 cm³/g.

In the method according to the invention the polybutylene terephthalate preferably has a Ti content to be determined by X-ray fluorescence analysis (XRF) according to DIN 51418 of 250 ppm.

The polyethylene terephthalate to be employed in the method according to the invention preferably contains at least 80 mol %, based on the dicarboxylic acid, of terephthalic acid radicals and at least 80 mol %, based on the diol component, of ethylene glycol radicals.

The method according to the invention preferably employs polyethylene terephthalate having an intrinsic viscosity in the range from about 30 cm³/g to 150 cm³/g measured analogously to ISO1628-1 in phenol/o-dichlorobenzene—1:1 parts by weight—at 25° C. using an Ubbelohde viscometer.

The method according to the invention preferably employs in addition to the polybutylene terephthalate and the polyethylene terephthalate at least one filler in amounts in the range from 0.001 to 70 parts by mass based on 100 parts by mass of polybutylene terephthalate. Particularly preferably employed therefor is a filler from the group of talc, mica, silicate, quartz, titanium dioxide, wollastonite, kaolin, kyanite, amorphous silicas, magnesium carbonate, chalk, feldspar, barium sulfate, glass spheres and fibrous fillers, in particular glass fibers or carbon fibers, especially particularly preferably glass fibers.

In a preferred embodiment the method according to the invention employs the filler to be employed with a silane-based adhesion promoter of general formula (I)

(X—(CH₂)_{q})ₖ—Si—(O—CᵣH₂ᵣ₊₁)₄₋ₖ (I)

wherein

X is NH₂—, carboxyl-, HO— or,

q is an integer from 2 to 10,

r is an integer from 1 to 5 and

k is an integer from 1 to 3.

The method according to the the invention preferably affords automotive interior parts, in particular trim pieces, plugs, electrical components or electronic components.

The examples which follow serve to elucidate the invention but have no limiting effect.

### EXAMPLES

TVOC

In order to determine the TVOC value of samples in the context of the present invention about 2 g in each case of a comminuted sample were according to the specification of VDA 277 (pieces of about 20 mg) weighed into a 20 mL sample vial having a screw cap and septum. These were heated in a headspace oven for 5 hours at 120° C. A small sample of the gas space was then injected into the gas chromatograph (Agilent 7890B GC) and analyzed. An Agilent 5977B MSD detector was used. The analysis was performed in triplicate and evaluated semi-quantitatively by means of acetone calibration. The result was determined in μgC/g. The threshold value not to be exceeded in the context of the present invention was 50 μgC/g. The analysis was based on the VDA 277 test specification.

VOC

The VOC value was determined when according to the specification of VDA 278 20 mg of a sample was weighed into a thermal desorption tube for a GERSTEL-TD 3.5 instrument with a frit from Gerstel (020801-005-00). Said sample was heated to 90° C. for 30 minutes in a helium stream and the thus-desorbed substances were frozen out at −150° C. in a downstream cold trap Once the desorption time had elapsed the cold trap was quickly heated to 280° C. and the collected substances were separated by chromatography (Agilent 7890B GC). Detection was effected using an Agilent 5977B MSD. Evaluation was effected semi-quantitatively by means of toluene calibration. The result was determined in μg/g. The threshold value not to be exceeded in the context of the present invention was 100 μg/g of total VOC and 5 μg/g of THF. The analysis was based on the VDA 278 test specification.

Reactants

Polybutylene terephthalate (PBT): LANXESS Pocan® B1300

Polyethylene terephthalate (PET): Equipolymers Lighter™ C93

Glass fiber (GF): LANXESS CS7967D, glass fibers made of E glass surface-coated with 0.9% by weight of silane having an average length in the range of 4.5 mm and an average filament diameter of 10 micrometers

Preparation of the Samples

### Example 1

The employed compounder was a ZSK 92 twin-screw extruder from Coperion. The compounder was operated at a melt temperature of about 270° C., a throughput of 4 tons per hour and a pressure of 300+/−50 mbar. The strands were cooled in a water bath, dried on a ramp in an air stream and then subjected to dry pelletization.

The example employed a compound based on a PBT molding compound containing 50 parts by mass of chopped glass fibers and 15 parts by mass of PET per 100 parts by mass of PBT. The thus-employed PBT had a TVOC value determined according to VDA 277 of 170 μgC/g.

The compounded material was then dried for 4 h at 120° C. in a dry air dryer and processed by injection molding under standard conditions (260° C. melt temperature, 80° C. mold temperature).

### Comparative Example

The employed compounder was a ZSK 92 twin-screw extruder from Coperion. The compounder was operated at a melt temperature of about 270° C., a throughput of 4 tons per hour and a pressure of 300+/−50 mbar. The strands were cooled in a water bath, dried on a ramp in an air stream and then subjected to dry pelletization.

The example employed a compound based on a PBT molding compound containing 43.3 parts by mass of chopped glass fibers. The thus-employed PBT had a TVOC value determined according to VDA 277 of 170 μgC/g.

The compounded material was dried for 4 h at 120° C. in a dry air dryer and processed by injection molding under standard conditions (260° C. melt temperature, 80° C. mold temperature).

TABLE 2

| Parts by mass based | VDA 277: | | | VDA 278: |
|---|---|---|---|---|
| on 100 parts by | TVOC | TVOC_{THF} | %_{THF} | THF |
| mass of PBT | [μgC/g] | [μgC/g] | [%] | [μg/g] |
| Comparative example: | | | | |
| 43.3 parts by mass of GF | | | | |
| Pellets | 60.3 | 54.7 | 91 | 4.9 |
| Component (injection molded) | 95.2 | 82.5 | 87 | 6.0 |
| Example (inventive): | | | | |
| 50 parts by mass of GF + 15 | | | | |
| parts by mass of PET | | | | |
| Pellets | 26.9 | 22.8 | 85 | 1.2 |
| Component (injection molded) | 33.8 | 28.8 | 85 | 1.6 |

Both in the inventive example and in the comparative example 5 multipurpose test specimens 1A according to DIN EN ISO 527-2 were in each case produced by injection molding and the THF content thereof determined according to VDA 277 and VDA 278 [component (injection molded)]. Tab. 2 reports the average values from respective sets of two measurements (duplicate determination). In the case of the investigated pellets 2×2 g (VDA277) or 2×20 mg (VDA278) were weighed and the THF content thereof determined in duplicate determination according to VDA 277 and VDA 278.

Tab. 2 shows the TVOC and TVOC_{THF} values determined according to the specification of VDA 277 on the dried pellets prior to injection molding and on the injection molded multipurpose test specimen 1A according to DIN EN ISO 527-2 and also the percentage of THF in the total emissions % THF. Also shown are the THF values measured according to the specification of VDA 278 on the dried granulate before use in injection molding and on the injection molded multi-purpose test specimen 1A according to DIN EN ISO 527-2.

The test results reported in Tab. 2 show that the addition of 15 parts by mass of PET to 100 parts by mass of PBT in the inventive example results in a marked reduction in the amount of THF and thus in the total emission. What is particularly surprising here is the extent of the reduction with −64.5% TVOC (33.8 compared to 95.2) and −65.1% TVOC_{THF} (28.8 compared to 82.5) and −73.3% VOC_{THF} (1.6 compared to 6.0) determined on the component which goes well beyond the diluting effect of the PBT by the PET. This effect on TVOC and the formation of THF from PBT during processing was unexpected for those skilled in the art since a person skilled in the art would not have expected the PET to have any reactive effect.

1. An automotive interior part containing a composition based on polybutylene terephthalate and polyethylene terephthalate, wherein based on 100 parts by mass of polybutylene terephthalate the composition employs 5 to 30 parts by mass of polyethylene terephthalate with the proviso that polyethylene terephthalate and polybutylene terephthalate are present not as a copolymer but as a mixture.

2. The automotive interior part as claimed in claim 1, having a TVOC to be determined according to VDA 277 of <50 μgC/g and a VOC_{THF} to be determined according to VDA 278 of <8 μg/g.

3. The automotive interior part as claimed in claim 1, wherein the polybutylene terephthalate has a viscosity number to be determined in a 0.5% by weight solution at 25° C. in a phenol/o-dichlorobenzene mixture in a weight ratio of 1:1 according to DIN EN ISO 1628-5 in a range from 50 to 220 cm³/g.

4. The automotive interior part as claimed in claim 1, wherein the polybutylene terephthalate has a Ti content to be determined by X-ray fluorescence analysis (XRF) according to DIN 51418 of ≤250 ppm.

5. The automotive interior part as claimed in claim 1, wherein the polyethylene terephthalate contains at least 80 mol %, based on the dicarboxylic acid, of terephthalic acid radicals and at least 80 mol %, based on the diol component, of ethylene glycol radicals.

6. The automotive interior part as claimed in claim 1, wherein the polyethylene terephthalate has an intrinsic viscosity in the range from about 30 cm³/g to 150 cm³/g measured analogously to ISO 1628-1 in phenol/o-dichlorobenzene—1:1 parts by weight—at 25° C. using an Ubbelohde viscometer.

7. The automotive interior part as claimed in claim 1, further comprising at least one filler in an amount in the range from 0.001 to 70 parts by mass based on 100 parts by mass of polybutylene terephthalate.

8. The automotive interior part as claimed in claim 7, wherein a filler from the group of talc, mica, silicate, quartz, titanium dioxide, wollastonite, kaolin, kyanite, amorphous silicas, magnesium carbonate, chalk, feldspar, barium sulfate, glass spheres and fibrous fillers is employed.

9. The automotive interior part as claimed in claim 8, wherein the fillers are treated with a silane-based adhesion promoter of general formula (I)
(X—(CH₂)_{q})ₖ—Si—(O—CrH₂ᵣ₊₁)₄₋ₖ (I)
wherein
X is NH₂—, carboxyl-, HO— or 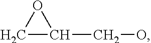
q is an integer from 2 to 10,
r is an integer from 1 to 5 and
k is an integer from 1 to 3.

10. The automotive interior part as claimed in claim 1, wherein the part is selected from trim pieces, plugs, electrical components or electronic components.

11. A method of preparing polybutylene terephthalate-based compounds for processing into injection molded parts having a TVOC to be determined according to VDA 277 of <50 μgC/g and a VOC_{THF} to be determined according to VDA 278 of <8 μg/g, comprising compounding polybutylene terephthalate with at least polyethylene terephthalate, wherein per 100 parts by mass of polybutylene terephthalate 5 to 30 parts by mass of polyethylene terephthalate are employed, with the proviso that polyethylene terephthalate and polybutylene terephthalate are present not as a copolymer but rather as a mixture.

12. A method for reducing the THF content in injection molded polybutylene terephthalate-based automotive interior parts, comprising compounding polybutylene terephthalate with at least polyethylene terephthalate, wherein per 100 parts by mass of polybutylene terephthalate 5 to 30 parts by mass of polyethylene terephthalate are present, with the proviso that polybutylene terephthalate and polyethylene terephthalate are present not as a copolymer but rather as a mixture.
